(19) United States
(12) Patent Application Publication
(10) Pub. No.: US 2018/0162689 A1
(43) Pub. Date: Jun. 14, 2018

(54) PIT SWITCH MODULE OF LANDING DOOR OF ELEVATOR

(71) Applicant: Otis Elevator Company, Farmington, CT (US)

(72) Inventors: Yong Hun Kim, Seoul (KR); Jong-Kon Bae, Hwaseong-si (KR); Kwon EunJin, Anyang-si (KR); Jusik Kim, Gimhae-si (KR)

(21) Appl. No.: 15/378,560

(22) Filed: Dec. 14, 2016

(51) Int. Cl. B66B 5/00; B66B 9/00; B66B 13/00; B66B 1/34

(52) U.S. Cl. CPC B66B 5/005; B66B 1/3415; B66B 13/00; B66B 9/00

(57) ABSTRACT

A pit switch module of elevator landing door for switching a mode of elevator between an inspection mode and a normal mode comprises a pit switch arranged that ON/OFF operation is configured to be done by an operator at a landing at the state when the elevator landing door has been closed such that the mode of elevator is switched before the operator enters a hoistway or after the operator leaves the hoistway.

### TECHNICAL FIELD

The present disclosure relates to a pit switch module of an elevator, and more particularly, to a pit switch module of an elevator landing door.

### BACKGROUND ART

An elevator pit switch means a typical switch to prevent a movement of an elevator car during work by being operated by an elevator operator before the operator enters a pit for repair, inspection, or cleaning. When the elector pit switch is operated, power applied to a motor or a brake is cut off.

In general, the pit switch is located in a pit. In detail, the pit switch is installed at a position that can be reached by a hand while the operator enters the pit from a landing, or at around a ladder for pit elevation installed on an inner wall of a hoistway at the lowest floor.

In spite of the existence of a pit switch, the elevator operator may be endangered by an unexpected movement of an elevator car. Accordingly, an elevator system with higher stability is required.

### DISCLOSURE OF THE INVENTION

The present disclosure is directed to a pit switch module of an elevator, which can enhance safety of the elevator system.

According to one aspect of the present disclosure, there is provided a pit switch module of elevator landing door for switching a mode of elevator between an inspection mode and a normal mode, the module comprising: a pit switch arranged that ON/OFF operation is configured to be done by an operator at a landing at the state when the elevator landing door has been closed such that the mode of elevator is switched before the operator enters a hoistway or after the operator leaves the hoistway.

Preferably, the pit switch is installed at the landing door.

Preferably, the pit switch is arranged at a back-side of the landing door.

According to one aspect of the present disclosure, there is provided a pit switch module further comprising a keyway configured to rotate by a key inserted from a front-side of the landing door, the keyway being arranged at the backside of the landing door.

Preferably, the pit switch is configured such that the ON/OFF operation is done based on a direction of rotation of the keyway.

According to one aspect of the present disclosure, there is provided a pit switch module further comprising a first connection portion, wherein the first connection portion is configured that its one end is connected to the keyway and its other end is connected to the pit switch such that the pit switch is pushed when the keyway rotates in one direction and the pit switch is pulled when the keyway rotates in other direction opposite to the one direction.

Preferably, the first connection portion comprises: a first connection member configured to move a predefined linear distance, the first connection member being connected to the pit switch; and a second connection member configured to connect the keyway and the first connection member such that the rotation of the keyway is transformed to a linear motion of the first connection member.

According to one aspect of the present disclosure, there is provided a pit switch module further comprising a landing door open/close switch configured to be ON/OFF based on a rotation direction of the keyway.

According to one aspect of the present disclosure, there is provided a pit switch module further comprising a second connection portion, wherein the second connection portion is configured that its one end is connected to the keyway and its other end is connected to the landing door open/close switch such that the landing door open/close switch is OFF when the keyway rotates in one direction and the landing door open/close switch is ON when the keyway rotates in other direction opposite to the one direction.

Preferably, the second connection portion comprises: a third connection member configured to move a predefined linear distance, the third connection member being connected to the landing door open/close switch; and a fourth connection member configured to connect the keyway and the third connection member such that the rotation of the keyway is transformed to a linear motion of the third connection member.

According to one aspect of the present disclosure, there is provided a pit switch module further comprising a rail portion configured to contact with the third connection member to prevent a linear motion of the third connection member in case where the landing door is open more than a predefined distance, the rail portion being arranged at an upper part of the back-side of the landing door.

According to one aspect of the present disclosure, there is provided a pit switch module further comprising a stopper configured to cause a positional variation of the fourth connection member with its restoring force.

Preferably, the ON/OFF of the landing door open/close switch is co-operated with the ON/OFF of the pit switch.

According to one aspect of the present disclosure, there is provided a pit switch module further comprising a cable configured to connect the pit switch to an inspection station installed in an elevator pit.

According to one aspect of the present disclosure, there is provided a pit switch module further comprising an additional pit switch installed in the elevator pit, wherein the additional pit switch is connected to the inspection station, and is connected to the pit switch in series.

According to one aspect of the present disclosure, there is provided an elevator landing door comprising a pit switch to switch a mode of elevator between an inspection mode and a normal mode, wherein the pit switch is arranged at the landing door.

According to one aspect of the present disclosure, there is provided an elevator landing door comprising a pit switch module, wherein the pit switch module is arranged that a mode of elevator is switched between an inspection mode and a normal mode and ON/OFF operation is configured to be done by an operator at a landing at the state.

According to one aspect of the present disclosure, there is provided an elevator system comprising: a hoistway comprising an elevator pit; a landing door configured to allow access of an operator to the elevator pit; a controller configured to control a motion of a elevator car, the controller telecommunicating with the elevator car; and a pit switch module configured to telecommunicate with the controller to control a motion of the elevator car so as to switch an elevator mode between a normal mode and an inspection mode, the pit switch module being arranged at the landing door.

According to one aspect of the present disclosure, there is provided a mode switching method for switching a mode of elevator between an inspection mode and a normal mode using a pit switch of an elevator landing door, the method comprising: switching an additional pit switch installed in an elevator pit from OFF state to ON state; switching the elevator landing door from open state to close state; and switching the pit switch from OFF state to ON state, the pit switch being arranged at the landing door.

Preferably, the mode switching method can further comprise switching a landing door open/close switch from OFF state to ON state, wherein the landing door open/close switch is cooperated with the pit switch.

### BRIEF DESCRIPTION OF THE DRAWINGS

FIG. 1 illustrates an elevator system.

FIG. 2 illustrates a front-side of the landing door viewed from the landing, according to an embodiment.

FIG. 3 illustrates a back-side of the landing door, according to an embodiment.

FIG. 4 illustrates a pit switch module arranged in the landing door, according to an embodiment.

FIG. 5 illustrates an operation portion at an upper side of the back-side of the landing door, according to an embodiment.

FIG. 6 is an enlarged view of a portion of FIG. 5.

FIG. 7 illustrates an operation of the pit switch module to change the normal mode to the inspection mode according to an embodiment.

FIG. 8 illustrates an operation of the pit switch module to change the inspection mode to the normal mode according to an embodiment.

FIG. 9 illustrates an operation of the pit switch module to change the normal mode to the inspection mode according to other embodiment.

FIG. 10 illustrates an operation of the pit switch module to change the inspection mode to the normal mode according to other embodiment.

### DETAILED DESCRIPTION

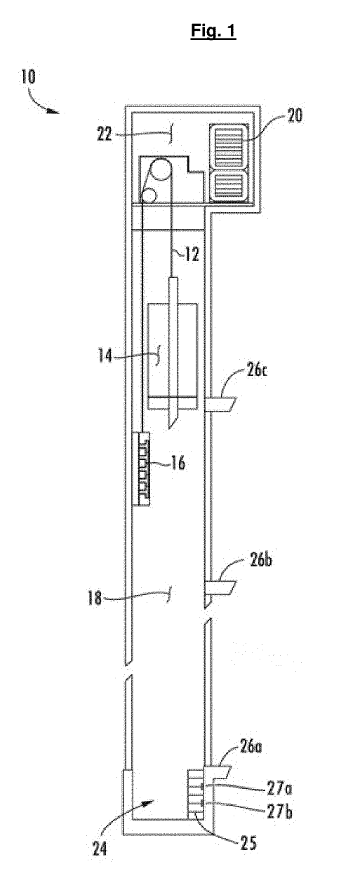

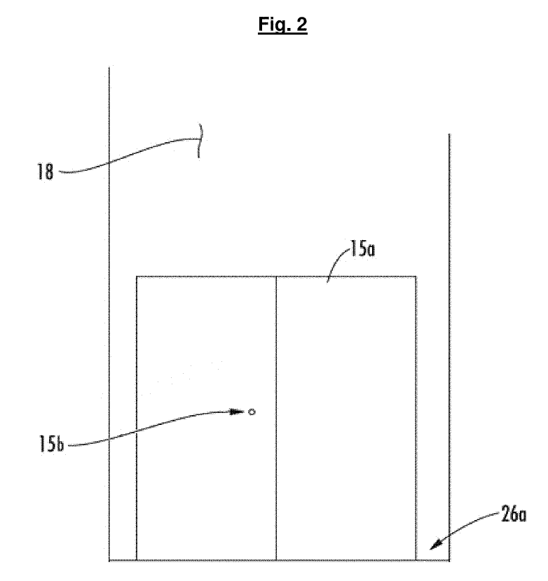

FIG. 1 illustrates an elevator system 10. The elevator system 10 may include a cable 12 (such cable 12 can be a rope or a belt) and an elevator car 14. The cable 12 is connected to a balance weight 16 and the elevator car 14 in a hoistway 18. The elevator car 14 elevates up and down in the hoistway 18 by a force transferred to the elevator car 14 through the cable 12 under the control of an elevator controller 20 generally located in a machine room 22 at the top of the hoistway 18. The elevator system 10 is configured to stop at a plurality of landings 26A to 26C so that passengers may enter and exit from the elevator car 14 through a set of hoistway door 15 (a landing door 15a at the landing 26a of FIG. 2) located at each of the landings 26A to 26C.

An elevator pit 24 is located at the bottom of the hoistway 18 below the lowest landing 26A. A ladder 25 for pit elevation is installed on an inner wall of the elevator pit 24. Furthermore, pit switches 27a and 27b are provided in the elevator pit 24. In the following description, the pit switches 27a and 27b provided in the pit are referred to as the additional pit switches 27a and 27b. The additional pit switches 27a and 27b may be installed at around the ladder 25 so that the operator on the ladder 25 may operate the additional pit switches 27a and 27b.

The additional pit switches 27a and 27b may be provided in a plural number in a direction along the depth of the pit. When any one of the additional pit switches 27a and 27b is off, the elevator car 14 stops running. In other words, when any one of the additional pit switches 27a and 27b is off, the elevator system 10 maintains an inspection mode. In the inspection mode, power applied to elements, for example, a motor or a controller, needed for the running of the elevator car 14 is cut off so that the running of the elevator car 14 of the elevator system is stopped. In contrast, in a normal mode, power is applied to the elements needed for the running of the elevator car 14 so that the elevator car 14 of the elevator system may run. In the present specification, it is assumed that the elevator system maintains the inspection mode when the pit switch is off, and maintains the normal mode when the pit switch is on. It is possible to set up the elevator system such that the elevator system maintains the normal mode when the pit switch is off, and maintains the inspection mode when the pit switch is on.

In the present embodiment, a pit switch module is provided to guarantee that the mode is finally changed from the inspection mode to the normal mode after the operator completely exits from the hoistway.

According to the present embodiment, the pit switch module includes a pit switch that is different from the above-described additional pit switches. The pit switch is configured to be turned on/off by the operator located at the landing when the landing door is closed. The operator being located at the landing 26a may signify that any part of the body of the operator is not located in the hoistway 18. For example, in the case of the additional pit switches 27a and 27b located in the elevator pit 24, the operator standing on the ladder 25 manipulates the additional pit switches 27a and 27b. In contrast, in the pit switch of the pit switch module according to the present embodiment, the operator may manipulate the pit switch without having any part of the body of the operator located in the hoistway 18.

The pit switch module according to the present embodiment is described in detail with reference to the accompanying drawings.

FIG. 2 illustrates a front-side of the landing door 15a viewed from the landing 26a, according to an embodiment. A key hole 15b for inserting a key may be formed in the front-side of the landing door 15a. For example, the operator located at the landing 26a may insert the key into the key hole 15b and rotate the key in one direction or in an opposite direction.

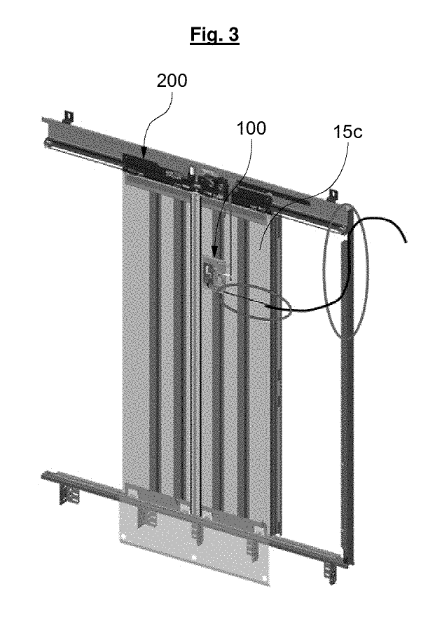

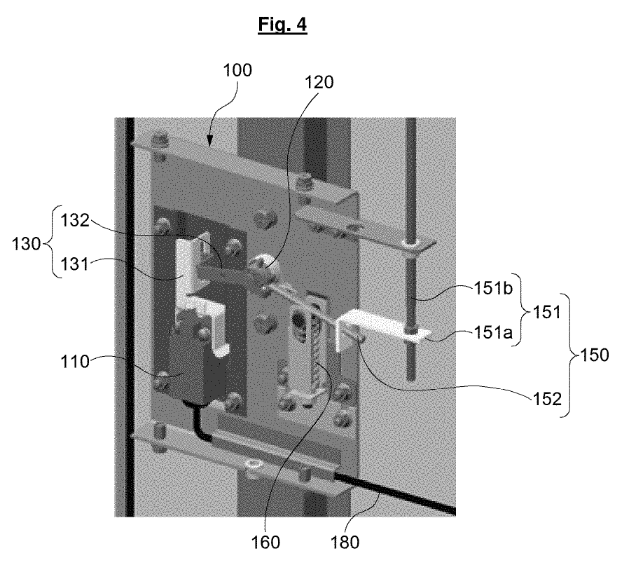

FIG. 3 illustrates a back-side 15c of the landing door 15a, according to an embodiment. Furthermore, FIG. 4 illustrates a pit switch module 100 arranged in the landing door 15a, according to an embodiment. In an embodiment, a pit switch 110 may be installed on the landing door 15a. For example, the pit switch 110 may be arranged on the back-side 15c of the landing door 15a.

In an embodiment, the pit switch 110 may be connected to a cable 180. The cable may connect the pit switch 110 to an inspection station (not shown) located in the elevator pit. Furthermore, the above-mentioned additional pit switches 27a and 27b may be connected to the inspection station. Furthermore, the pit switch 110 according to the present embodiment may be serially connected to the additional pit switches 27a and 27b. According to the above structure, the inspection mode may be maintained when any one of the additional pit switches 27a and 27b and the pit switch 110 is in an off state. Furthermore, when both of the additional pit switches 27a and 27b and the pit switch 110 are in an on state, the normal mode may be maintained.

Furthermore, a keyway 120 may be arranged on the back-side 15c of the landing door. The keyway 120 may be rotated by the key inserted from the front-side 15a of the landing door. For example, when the key is rotated in one direction viewed from the front-side of the landing door 15a, the keyway 120 is rotated in a direction opposite to the one direction viewed from the back-side 15c of the landing door 15a. In this state, the one direction may denote a clockwise direction or a counterclockwise direction. When the one direction is a clockwise direction, the opposite direction to the one direction may be a counterclockwise direction. When the one direction is a counterclockwise direction, the opposite direction to the one direction may be a clockwise direction.

In the following description, the rotation of the keyway in one direction may signify that the keyway is rotated in the one direction with respect to the back-side of the landing door.

The pit switch 110 according to the present embodiment may be turned on or off according to the rotation direction of the keyway 120. For example, when the keyway 120 is rotated in one direction, the pit switch 110 is changed from an on state to an off state. When the keyway 120 is rotated in a direction opposite to the one direction, the pit switch 110 is changed from the off state to the on state.

In an embodiment, a first connection portion 130 connects the pit switch 110 and the keyway 120. In other words, one side of the first connection portion 130 is connected to the keyway 120 and the other side of the first connection portion 130 is connected to the pit switch 110.

The first connection portion 130 may change the rotation motion of the keyway 120 to a pressing motion of the pit switch 110. In detail, when the keyway 120 is rotated in one direction, the first connection portion 130 pushes the pit switch 110. When the keyway 120 is rotated in a direction opposite to the one direction, the first connection portion 130 pulls the pit switch 110 to be released from a pushed state.

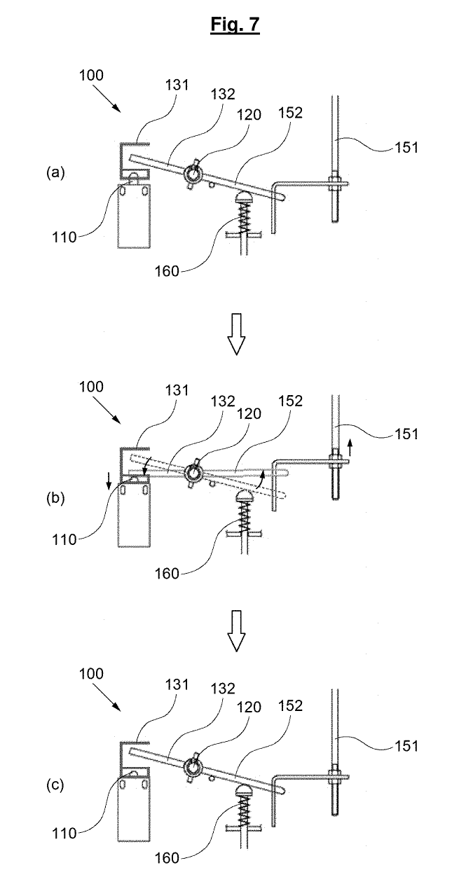

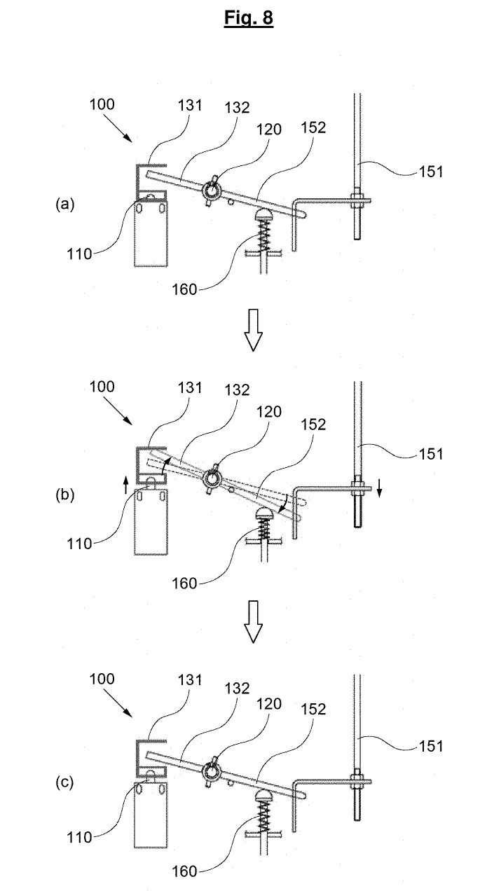

In an embodiment, the first connection portion 130 may include first and second connection members 131 and 132. The first connection member 131 is connected to the pit switch 110 and moves a preset linear distance. To be specific, the first connection member 131 is connected to a button portion of the pit switch 110. The second connection member 132 may connect the keyway 120 and the first connection member 131 to change the rotation of the keyway 120 to a linear motion of the first connection member 131. For example, referring to FIG. 4, the second connection member 132 may be in the form of a cantilever. The fixed end of a cantilever is fixed on the keyway 120 and may be rotated with the keyway 120. The free end of a cantilever may be configured to be caught by the first connection member 131. A detailed description on the motion of the first connection portion 130 is presented below with reference to FIGS. 7 and 8.

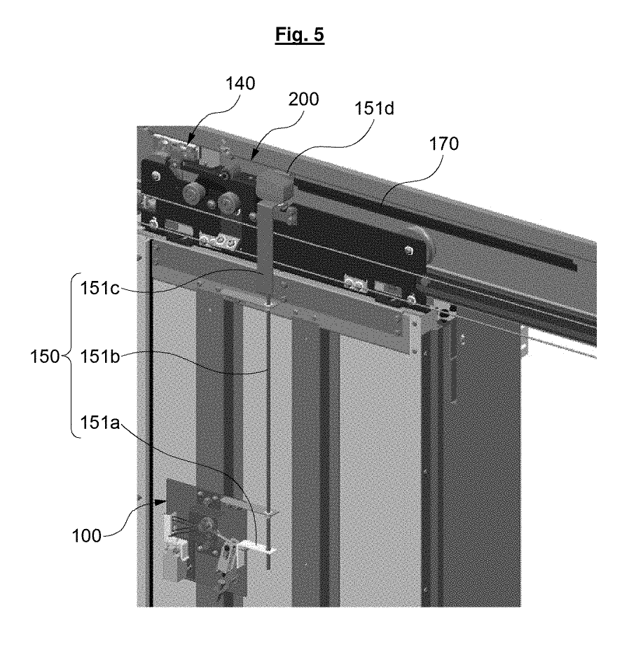

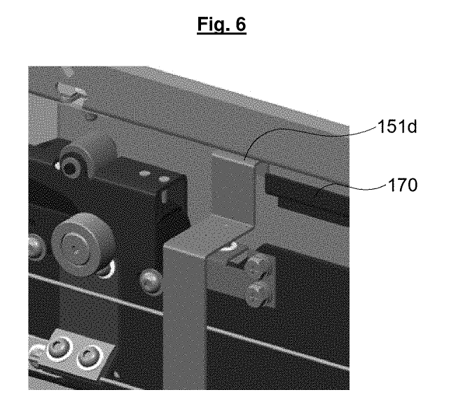

FIG. 5 illustrates an operation portion 200 at an upper side of the back-side of the landing door 15a, according to an embodiment. FIG. 6 is an enlarged view of a portion of FIG. 5. The operation portion 200 may include various mechanical parts linked with opening/closing motion of the landing door.

The pit switch module 100 according to the present embodiment may further include a landing door open/close switch 140. The landing door open/close switch 140 may be a switch that switches between an off state in which the landing door is opened/closed by a force that is externally applied and an on state in which the landing door is not opened/closed even when the external force is applied. The external force may be a force applied by the operator to the landing door. The landing door open/close switch 140 may be understood as a part of the operation portion or a separate element.

The turn on/off of the landing door open/close switch 140 may be linked with the turn on/off of the pit switch 110. For example, when the landing door open/close switch 140 is switched to the off state, the pit switch 110 may also be switched to the off state. When the landing door open/close switch 140 is switched to the on state, the pit switch 110 may also be switched to the on state.

Furthermore, the landing door open/close switch 140 may be configured to be turned on/off according to the rotation direction of the keyway 120. For example, when the keyway 120 is rotated in one direction, the landing door open/close switch 140 may be switched to the off state. When the keyway 120 is rotated in a direction opposite to the one direction, the landing door open/close switch 140 may be switched to the on state.

In an embodiment, the landing door open/close switch 140 and the keyway 120 may be connected by a second connection portion 150. The second connection portion 150 has one side connected to the keyway 120 and the other side connected to the landing door open/close switch 140. When the keyway 120 is rotated in one direction, the second connection portion 150 turns the landing door open/close switch 140 off. When the keyway 120 is rotated in a direction opposite to the one direction, the second connection portion 150 turns the landing door open/close switch 140 on.

In detail, the second connection portion 150 may include third and fourth connection members 151 and 152. The third connection member 151 is connected to the landing door open/close switch 140 and may move a preset linear distance. The fourth connection member 152 may connect the keyway 120 and the third connection member 151 to change the rotation of the keyway 120 to the linear movement of the third connection member 151. Although the third connection member 151 is illustrated to include a plurality of parts 151a, 151b, and 151c, the present disclosure is not limited thereto. In other words, the third connection member 151 may be integrally formed.

The pit switch module 100 according to the present embodiment may further include a stopper 160. The stopper 160 may include an elastic member to cause a positional change of the fourth connection member 152 by using a restoration force.

In the following description, the operation of the pit switch module 100 including the pit switch 110, the keyway 120, the first and second connection portions 130 and 150, and the stopper 160, according to an embodiment, is described in detail with reference to FIGS. 7 and 8.

FIG. 7 illustrates an operation of the pit switch module to change the normal mode to the inspection mode according to an embodiment. Furthermore, FIG. 8 illustrates an operation of the pit switch module to change the inspection mode to the normal mode according to an embodiment.

A state (a) of FIG. 7 indicates the pit switch module 100 in the normal mode. States (b) and (c) of FIG. 7 indicate the pit switch module 100 in the inspection mode. Referring to the states (a) and (b) of FIG. 7 altogether, when the keyway 120 is rotated in one direction (rotated in a counterclockwise direction on the drawing), the second connection member 132 is rotated in one direction with the keyway 120. Then, the first connection member 131 is moved downward and pushes the pit switch 110. The pit switch 110 is pushed and changed to an off state. With the rotation of the keyway 120 in the one direction, the fourth connection member 152 is rotated in the one direction with the keyway 120. The third connection member 151 is move upward and then the landing door open/close switch 140 is changed to an off state. In other words, the pit switch 110 and the landing door open/close switch 140 may be changed to the off state together. The state (c) of FIG. 7 illustrates that the pit switch module 100 still remains in the inspection mode even when the keyway 120 is returned to the original position. Referring to both states (b) and (c) of FIG. 7, when the keyway 120 is returned to the original position (the state before the rotation in the one direction), the second and fourth connection members 132 and 152 connected to the keyway 120 may also be returned to the original positions. However, since the pit switch 110 still maintains a pushed state, the inspection mode may be maintained. Since the landing door open/close switch 140 and the pit switch 110 both are in the off state, the operator may easily open the landing door and enter the pit in a safe situation. The state (b) of FIG. 7 may be changed to the state (c) of FIG. 7 by removing the key from the key hole.

A state (a) of FIG. 8 illustrates the pit switch module 100 in the inspection mode. The state (a) of FIG. 8 may illustrate substantially the same situation as the state (c) of FIG. 7. State (b) and (c) of FIG. 8 illustrate the pit switch module 100 in the normal mode. Referring to the states (a) and (b) of FIG. 8 altogether, when the keyway 120 is rotated in a direction opposite to the one direction (rotated in a clockwise direction on the drawing), the second connection member 132 is rotated with the keyway 120 in the direction opposite to the one direction. The first connection member 131 is moved upward and the pit switch 110 is released from the pushed state. The pit switch 110 is pulled and changed to the on state. With the rotation of the keyway 120, the fourth connection member 152 is rotated with the keyway 120 in the direction opposite to the one direction the keyway 120. The third connection member 151 linked with the fourth connection member 152 is moved downward and changes the landing door open/close switch 140 to the on state. In other words, both the pit switch 110 and the landing door open/close switch 140 may be changed to the on state. In other words, the locking (LOCK) of the landing door and the final change to the normal mode may be generated by being linked with each other. Referring to the states (b) and (c) of FIG. 8, while being rotated, the fourth connection member 152 may compress the stopper 160. The fourth connection member 152 may be returned to the original position by a restoration force of the elastic member of the stopper 160 (see the state (c) of FIG. 8). A state (c) of FIG. 8 illustrates that the pit switch module still remains in the normal mode even when the keyway 120 is returned to the original position. Referring to the states (b) and (c) of FIG. 8 altogether, when the keyway 120 is returned to the original position (the state before the rotation in the direction opposite to the one direction), the second and fourth connection members 132 and 152 connected to the keyway 120 may also be returned to the original positions. However, since the pit switch 110 still maintains a pulled state, the normal mode may be maintained. The state (b) of FIG. 8 may be changed to the state (c) of FIG. 8 by removing the key from the key hole.

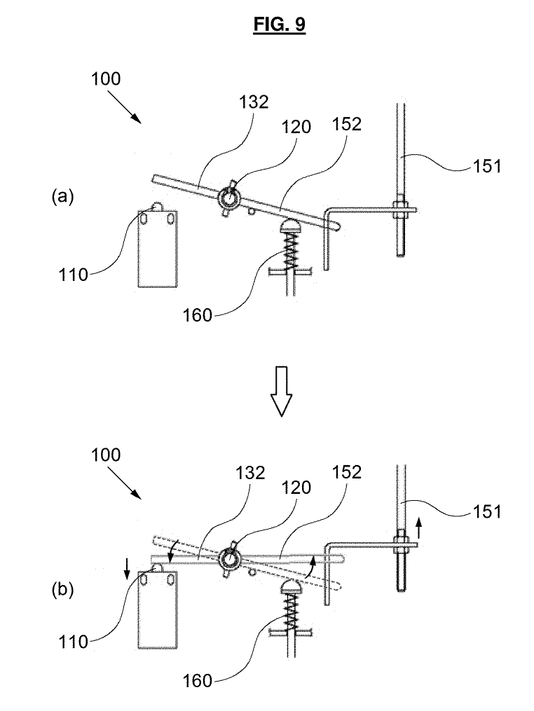

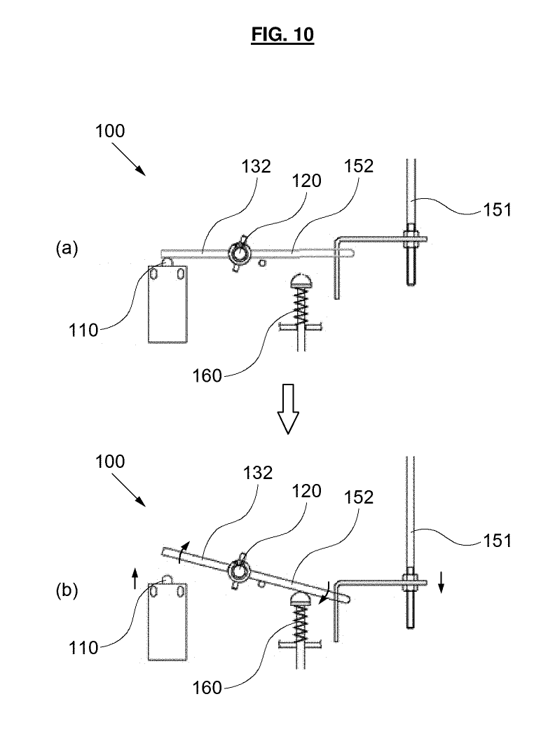

So for, the pit switch of the push type has been given as an example, however, the type of the pit switch is not limited to the push type. For example, the pit switch can also be configured to be touch type. In the following description, the operation of the pit switch 110 of the touch type, according to an embodiment, is described in detail with reference to FIGS. 9 and 10.

FIG. 9 illustrates an operation of the pit switch module to change the normal mode to the inspection mode according to other embodiment. FIG. 10 illustrates an operation of the pit switch module to change the inspection mode to the normal mode according to other embodiment.

A state (a) of FIG. 9 indicates the pit switch module 100 in the normal mode. A State (b) of FIG. 9 indicates the pit switch module 100 in the inspection mode. Referring to FIG. 9, when the keyway 120 is rotated in one direction (rotated in a counterclockwise direction on the drawing), the second connection member 132 is rotated in one direction with the keyway 120. Then, the pit switch 110 is touched and changed to an off state. As long as the second connection member 132 is touched with a button portion of the pit switch 110, the inspection mode can be maintained.

A state (a) of FIG. 10 indicates the pit switch module 100 in the inspection mode. A State (b) of FIG. 10 indicates the pit switch module 100 in the normal mode. The states (a) and (b) of FIG. 10 may illustrate substantially the same situation as the states (b) and (a) of FIG. 9, respectively. Referring to FIG. 10, when the keyway 120 is rotated in a direction opposite to the one direction (rotated in a clockwise direction on the drawing), the second connection member 132 is rotated with the keyway 120 in the direction opposite to the one direction. Then, the pit switch 110 is released from the touched state and changed to the on state. While the second connection member 132 is not touched with a button portion of the pit switch 110, the normal mode can be maintained.

Meanwhile, in the embodiment related to FIG. 9 and FIG. 10, the key is configured to be removed from the key hole, or to be inserted into the key hole, not only in the state (a) of FIG. 9 (or the state (b) of FIG. 10) but also in the state (b) of FIG. 9 (or the state (a) of FIG. 10). When the key is removed from the key hole, the current state (or the current mode) can be maintained.

Although it is illustrated in FIG. 9 and FIG. 10 that the second connection member 132 directly touches the button portion of the pit switch 110, the present disclosure is not limited thereto. For example, when the second connection member 132 are connected to the pit switch 110 by the first connection member 131, it is obvious for the person skilled in the art that what touches the button portion of the pit switch 110 is the first connection member 131 instead of the second connection member 132.

The change of modes occurs when the landing door of the elevator system is closed, which is described in detail with reference to FIG. 6.

In an embodiment, the pit switch module of the elevator landing door may further include a rail portion 170. The rail portion 170 may be formed to catch the third connection member 151.

A hook 151d is formed at one end of the third connection member 151c. The hook 151d may be caught on the rail portion 170 when the landing door is opened more than a preset distance. According to the above structure, when the landing door is opened more than a preset distance, a linear movement of the third connection member 151 (or an auxiliary member) may be prevented. Furthermore, when the linear movement of the third connection member 151 (or an auxiliary member) is prevented, the rotation of the keyway 120 may be prevented as well. Accordingly, when the landing door is opened, even when the key is inserted to rotate the keyway 120, the change from the inspection mode to the normal mode may be prevented. FIG. 6 illustrates a state in which the hook 151d is not caught on the rail portion 170, that is, the door is completely closed.

While several embodiments have been disclosed, it will be apparent to those of ordinary skill in the art that aspects of the present disclosure include many more embodiments and implementations. Accordingly, aspects of the present disclosure are not to be restricted except in light of the attached claims and their equivalents. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

1. A pit switch module of elevator landing door for switching a mode of elevator between an inspection mode and a normal mode, the module comprising:
a pit switch configured that ON/OFF operation can be done by an operator at a landing at the state when the elevator landing door has been closed such that the mode of elevator is switched before the operator enters a hoistway or after the operator leaves the hoistway.

2. A pit switch module of elevator landing door according to claim 1, wherein the pit switch is installed at the landing door.

3. A pit switch module of elevator landing door according to claim 1, wherein the pit switch is arranged at a back-side of the landing door.

4. A pit switch module of elevator landing door according to claim 3, further comprising a keyway configured to rotate by a key inserted from a front-side of the landing door, the keyway being arranged at the backside of the landing door.

5. A pit switch module of elevator landing door according to claim 4, wherein the pit switch is configured such that the ON/OFF operation is done based on a direction of rotation of the keyway.

6. A pit switch module of elevator landing door according to claim 4, further comprising a first connection portion, wherein the first connection portion is configured that its one end is connected to the keyway and its other end is connected to the pit switch such that the pit switch is pushed when the keyway rotates in one direction and the pit switch is pulled when the keyway rotates in other direction opposite to the one direction.

7. A pit switch module of elevator landing door according to claim 6, wherein the first connection portion comprises:
a first connection member configured to move a predefined linear distance, the first connection member being connected to the pit switch; and
a second connection member configured to connect the keyway and the first connection member such that the rotation of the keyway is transformed to a linear motion of the first connection member.

8. A pit switch module of elevator landing door according to claim 4, further comprising a landing door open/close switch configured to be ON/OFF based on a rotation direction of the keyway.

9. A pit switch module of elevator landing door according to claim 8, further comprising a second connection portion, wherein the second connection portion is configured that its one end is connected to the keyway and its other end is connected to the landing door open/close switch such that the landing door open/close switch is OFF when the keyway rotates in one direction and the landing door open/close switch is ON when the keyway rotates in other direction opposite to the one direction.

10. A pit switch module of elevator landing door according to claim 9, wherein the second connection portion comprises:
a third connection member configured to move a predefined linear distance, the third connection member being connected to the landing door open/close switch; and
a fourth connection member configured to connect the keyway and the third connection member such that the rotation of the keyway is transformed to a linear motion of the third connection member.

11. A pit switch module of elevator landing door according to claim 10, further comprising a rail portion configured to contact with the third connection member to prevent a linear motion of the third connection member in case where the landing door is open more than a predefined distance, the rail portion being arranged at an upper part of the back-side of the landing door.

12. A pit switch module of elevator landing door according to claim 10, further comprising a stopper configured to cause a positional variation of the fourth connection member with its restoring force.

13. A pit switch module of elevator landing door according to claim 8, wherein the ON/OFF of the landing door open/close switch is co-operated with the ON/OFF of the pit switch.

14. A pit switch module of elevator landing door according to claim 1, further comprising a cable configured to connect the pit switch to an inspection station installed in an elevator pit.

15. A pit switch module of elevator landing door according to claim 14, further comprising an additional pit switch installed in the elevator pit, wherein the additional pit switch is connected to the inspection station, and is connected to the pit switch in series.

16. An elevator landing door comprising a pit switch to switch a mode of elevator between an inspection mode and a normal mode, wherein the pit switch is arranged at the landing door.

17. An elevator landing door comprising a pit switch module, wherein the pit switch module is arranged that a mode of elevator is switched between an inspection mode and a normal mode and ON/OFF operation is configured to be done by an operator at a landing at the state.

18. An elevator system comprising:
a hoistway comprising an elevator pit;
a landing door configured to allow access of an operator to the elevator pit;
a controller configured to control a motion of a elevator car, the controller telecommunicating with the elevator car; and
a pit switch module configured to telecommunicate with the controller to control a motion of the elevator car so as to switch an elevator mode between a normal mode and an inspection mode, the pit switch module being arranged at the landing door.

19. A mode switching method for switching a mode of elevator between an inspection mode and a normal mode using a pit switch of an elevator landing door, the method comprising:
switching an additional pit switch installed in an elevator pit from OFF state to ON state;
switching the elevator landing door from open state to close state; and
switching the pit switch from OFF state to ON state, the pit switch being arranged at the landing door.

20. A mode switching method according to claim 19, further comprising switching a landing door open/close switch from OFF state to ON state, wherein the landing door open/close switch is cooperated with the pit switch.
